(19) United States
(12) Patent Application Publication
(10) Pub. No.: US 2021/0217537 A1
(43) Pub. Date: Jul. 15, 2021

(54) Ion Beam Device and Method for Generating Heat and Power

(71) Applicant: QUANTUM SPRING RESEARCH PTY LTD, Springfield Lakes (AU)

(72) Inventor: Russell Blake, Springfield Lakes (AU)

(21) Appl. No.: 17/054,879

(22) PCT Filed: May 11, 2019
(86) PCT No.: PCT/AU2019/050441

§ 371 Date: Nov. 12, 2020

(30) Foreign Application Priority Data
May 13, 2018 (AU) 2018901635

(51) Int. Cl. G21B 3/00

(52) U.S. Cl. CPC G21B 3/006; G21B 3/00

(57) ABSTRACT

The present disclosure is directed to a device and method which generate heat and electrical power by controlling the density, focus, and speed of an ion beam from a low-power plasma in a plasma chamber from which the ion beam is extracted into a reaction chamber. This optionally enriches a target into a target hydride to initiate and sustain heat and optionally a cold fusion reaction in said target, recovering heat energy from said reaction to provide heating, and/or to generate electrical power. This optionally replenishes the target with additional ionic fuel and/or deposits additional target material when additional heat is not required, whilst during heating and optional enrichment/deposition and cold fusion cycles extracting excess fuel from the chambers to recombine if necessary with any fuel byproduct from the source fuel to then reuse as source fuel.

### CROSS-REFERENCE TO RELATED APPLICATIONS

This application is the United States national phase of International Application No. PCT/AU2019/050441 filed May 11, 2019, and claims priority to Australian Patent Application No. 2018901635 filed May 13, 2018, e disclosures of which are hereby incorporated by reference in their entirety.

### BACKGROUND OF THE INVENTION

### Technical Field

Power and Heat Generation.

### Background Art

Since the discovery of cold fusion in 1989 [M. Fleischmann, S. Pons and M. Hawkins, J. Electroanal. Chem., 261 (1989) 301.], it has been characterized as having the ability to generate heat well in excess of input energy and also well in excess of any known chemical reaction. In the intervening decades there have been thousands of scientific articles as well as hundreds of patent applications in the field. Due to difficulties reproducing the experimental observations and the lack of an adequate theoretical explanation for the observations, there has been some prejudice against the term “cold fusion” which has led to the coinage of such euphemisms as LENR (Low-Energy Nuclear Reaction), LANR (Lattice Assisted Nuclear Reactions) or CANR (Chemically Assisted Nuclear Reactions.) For an overview of experimental results from the first quarter century of cold fusion research, see [Storms, E., A Student's Guide to Cold Fusion, LENR-CANR.org (2003)]. Since within the past 10 years it has become possible to reproduce cold fusion at will, it is now reasonable to dispense with these euphemisms and use the original term cold fusion in this disclosure.

The phenomenon was first observed by Fleischmann and Pons [cited above] in an electrolysis experiment. In a 300° K Heavy Water (99.5% D₂O, 0.5% H₂O) solution of 0.1 M LiOD forming LiO⁻ and D⁺ ions, 1.54V was applied between a Platinum anode (positively charged) and a palladium cathode (negatively charged.) In an initial enrichment process, the palladium first absorbed the deuterium ions into interstices within the Pd lattice, a known capability of Group 10 elements of the Periodic Table. As noted by [Storms], the degree of enrichment can be measured by weight or lattice distortion but is usually measured by the resistance of the lattice, see for example [Bok et al., Journal of Condensed Matter Nuclear Science 24 (2017) 25-31]. When the enrichment reached a level between 0.9 to 1.3 D⁺ ions to lattice atoms, excess heat was detected far beyond what could be explained by any known chemical process, leading to the conclusion that nuclear fusion was taking place between additional incoming D⁺ ions and the enrichment D⁺ ions previously trapped in the metal lattice, yielding helium (⁴He). Many scientific papers and patents have followed a variant of this paradigm, some completely separating the enrichment phase from the cold fusion phase. A recent representative of the patents employing this approach is [JP2015090312A, 2013]. A disadvantage of this approach is that it is difficult to control with any precision the point at which enrichment of the lattice stops and the cold fusion reaction starts. This difficulty has been overcome by enriching the target lattice separately, then utilizing the prepared target in a cold fusion reaction chamber. But this separation itself renders continuous operation awkward once the enrichment is depleted. Another problem is that it is difficult to control the speed and direction of ions entering the lattice or to independently vary their volume during either enrichment or reaction phases. A significant impediment to using this approach in practice is the simple fact that, to generate enough heat to supply a useful amount of power, the electrolyte itself will quickly evaporate.

Another approach is to use a Group 10metal such as nickel, or a nickel-palladium alloy, sometimes combined with ZrO₂, formed into nanoparticles or metallic grains, and surrounded by D₂ (or H₂) gas. By creating grains of nanoparticles, the metal alloy exposes increased surface area to the gas. This is advantageous due to the experimental observation that most fusion reactions occur near the surface of the target alloy. To obtain a sustained reaction, the gas is raised to a moderate (compared to hot fusion at 100 million ° C.) temperature, from 300 to 500° C., which energizes the D sufficiently to enrich the alloy lattice and eventually cause fusion events. A current recent article describing this approach is [Kitamura, A., et. al., J. Condensed Matter Nucl. Sci. 24 (2017) 202-213]. Typical of patents proposing to use this approach is [CA2924531C, 2013]. One advantage of this method is the assertion by the practitioners that cold fusion is 100% reproducible, a goal sought for many years. Nonetheless, this approach has the disadvantage that a fair amount of heat energy must be expended to sustain the process, so it is not entirely clear that enough excess heat from fusion can be generated to overcome the cost to operate a device. Even if there is enough fusion heat to overcome the cost, any device that can operate at a lower power consumption will be more efficient. There is no way to control the direction or speed at which the D gas atoms encounter the surfaces of the particles, leading to a large number of inefficient collisions that do not result in fusion. There has been difficulty maintaining a uniform distribution of nanoparticles throughout the target, leading to random hot spots. The dependence on a collection of nanoparticles as target would lead to unpredictable operation when in motion should the particles be tossed about. Extracting heat from a collection of particles is also problematic. Furthermore, continuous operation of the device over a long period of time is difficult since once the grains are depleted of enriched D, the entire apparatus must be shut down whilst the nanoparticles re-absorb more D; there is no simple way to alternate between absorption of D by some particles and production of cold fusion by others.

A third approach is to create a solid from the nanoparticles using a Group 10 alloy such as Ni—Pd—ZrO₂, infuse the solid with deuterium, form the result into a package like a solid resistor, and pass a current through it to generate fusion heat. A recent article on this approach is [Swartz, M, et.al., J. Condensed Matter Nucl. Sci. 15 (2015) 66-80]. A recent patent of this type is [US20160329118A1, 2015]. In the past the proponents have mentioned some difficulties with the parts experiencing an “avalanche” failure mode, wherein the fusion becomes uncontrolled and the part melts, an issue being addressed by the practitioners by limiting the current. One disadvantage of this approach is that it may be difficult to scale the phenomenon to a level that can generate a practical amount of heat or electricity. The inventors assert to power a Stirling engine (invented in 1816) with this technology, however, this has the disadvantage that it produces relatively little power, so is best suited to low power applications such as charging deep cycle batteries. Many practical applications of fossil fuel engines require more power than can be generated by a Stirling engine. This approach has the disadvantage that control of the speed and paths of the D⁺ ions in the lattice is indirect and approximate. Long term operation is also difficult with this approach since once the D⁺ is depleted, there is no way to recreate the device without rebuilding it.

A difficulty encountered by all these methods is that the entire surface of the cathode is subject to entry by impacting ions. Therefore, no portion of the target is available for the cold fusion reaction whilst another portion of the electrode in which enrichment has been partially or wholly depleted is enriched again with nuclei or deposited again with target material, making long-term operation problematic. A second difficulty encountered by all these methods is that if the power generated by the cold fusion reaction is insufficient to the application, there is no alternative operating mode for supplementing power up to the required level.

Experiments have been conducted on the loading of deuterium into metals using a duoplasmatron device, which creates a beam of protons or deuterons in a partial vacuum that impinge the target made of Ytterbium or Titanium which is retained in a vacuum chamber, as described in the series of articles following [Yuki, H., et. al., Metal. J. Phys. Soc. Japan, 1997. 64(1): p. 73-78]. In this series of experiments, an electrode is coated with a paste which is then dried prior to use. The combination is then heated by applying high-power current. A plasma is formed from which an ion beam is extracted with negatively charged electrodes to study the ability of various metals to absorb the ions. The experiments show that the amount of cold fusion produced is directly controlled by the current and voltage strength of the extracted ion beam. This overcomes disadvantages of the other approaches in that the precise amount and speed of incoming ions can be controlled, thus controlling the amount of cold fusion heat produced. But the approach has disadvantages of requiring a high-power input for the duoplasmatron ion source, delivering a short lifetime as the duoplasmatron's paste erodes, and yielding a low-current beam of only 1 mA which does not generate enough cold fusion to overcome the cost of the input power. More recently a duoplasmatron producing a higher beam current of 200 mA has been deployed [R. Scrivens, et. Al., Proc. IPAC2011, San Sebastian, Spain 2011 3472-4], however the duoplasmatron in that case has the disadvantage of requiring an even higher input power of 50 kW.

As noted in the references [Fleischmann and Pons], [Storms], [Bok], [Kitamura], [Swartz] and [Yuki], cold fusion begins after deuterium ions have become embedded in the surface of a lattice in a ratio of D⁺ to lattice atoms between 0.9 and 1.3. Although even Fleischmann and Pons themselves had great difficulty reproducing cold fusion in the years immediately following its discovery in 1989, the extensive literature on the topic of cold fusion since then abounds with details of the conditions required of the target lattice for the onset of cold fusion, as summarized by [Storms]. Several facts emerge from the literature in the prior art: (1) some stress in the structure of the metal lattice helps to create the necessary conditions, for example as indicated by [Kitamura] and [Swartz] by adding ZrO₂ and Ni to form an alloy with Pd; (2) cold fusion is unlikely to emerge until the ratio of D nuclei to lattice nuclei is between 0.9 to 1.3 [Swartz] & [Kitamura]; and (3) the proportion of D to lattice nuclei is reflected in the resistance of the lattice, permitting the condition to be monitored [Bok]. These conditions are now being combined to create cold fusion in 100% of the attempts by [Swartz] and [Kitamura], for example. (It is likely point (1) above is the reason Fleischmann and Pons among others had difficulty reproducing cold fusion in the years following its initial observation. It is believed now that the initial Pd sample they used had unknown impurities, whereas subsequent attempts to reproduce cold fusion invariably began by obtaining the purest samples of Pd available.)

A low-power, low-temperature plasma for providing ions can be created using a low-power microwave generator, a technique used to provide proton beams for linear accelerators as for example in [Neri, L., et. Al., Review of Scientific Instruments 85, 02A723 (2014)]. This technique has not previously been used for enriching targets for cold fusion nor for generating heat energy nor cold fusion. The energy of the ions extracted from the plasma can be increased by accelerating them using additional electrodes, resulting in ions with higher kinetic energy. In current applications of the device for medical and physics research applications a Radio Frequency Quadrupole (RFQ) is used to accelerate the ions [Neri], but this has the disadvantage of requiring high input power. If high input power is not available, it is possible to revert to the earlier designs of the original linear accelerators devised by Cockcroft and Walton, which can provide highly accelerated ion beams at a very low cost of input power once the electrodes are charged [Cockcroft and Walton, Nature, Feb. 13, 1932]. Using such a device an ion beam can be accelerated to any required level using low-power electrodes, limited only by size, weight and keeping energies low enough to avoid undesirable radiation from the impact of the ions with the target. For a discussion of Cockcroft-Walton (CW) accelerator design see [Merritt & Asare, Voltage Multipliers and the Cockcroft-Walton generator, SemanticScholar.org (2009)]. There is considerable literature on this type of accelerator, which has found application in electron microscopes as well as in Cathode Ray Tube (CRT) televisions and CRT computer monitors well into the early 2000's. The CW accelerator can be tuned to increase or decrease the speed of the ions by increasing or decreasing its voltage, an operation some may still recall performing as they increased or decreased the brightness of CRT computer monitors. When used to accelerate ions, once charged the CW accelerator requires no current, and therefore no power. It presents a static electric field to the ions, which accelerate to the speed dictated by the strength of the field. The fixed field strength will generate an ion beam of constant speed as it exits the accelerator. Upon impact with a target this will generate heat. In [Neri], the amount of heat generated by the beam is charted, with the objective of the research being to reduce the heat created by diffusing the beam with magnetic fields.

Once heat has been created using the collision of the ion beam with the target and optionally by cold fusion with embedded nuclei, it can be used directly for example to heat water or a hydrocarbon and the resulting vapor or steam can optionally be converted into electrical power. This conversion has received some discussion in the prior art. For example, patent [CN206505727U] discloses a control system which uses a steam turbine for this purpose. This approach has the disadvantage that it creates cold fusion using muon-catalyzed fusion, to which it attaches a conventional steam power generation control system commonly used in power plants. Muon-catalyzed fusion was first proposed in 1947 [Frank, Nature. 160 (4048): 525]. This form of cold fusion occurs when the electron surrounding the deuterium nucleus is replaced by a muon, which being much heavier than the electron orbits closer to the nucleus, thus reducing the distance between nuclei and enhancing the chance of a fusion event. Muon-catalyzed fusion has the disadvantages that muons take a lot of energy to generate, live very short lives, tend to stick to the helium product of fusion thus removing themselves from the reaction chain, and generally appears to require more input power than it can generate. Patent [DE19845223A1] discloses a method for enhancing the performance of a steam engine by injecting the steam with elements that fuse, increasing the engine power. This does not directly address the issue of converting the heat of an external, scalable fusion reaction into electricity. Of more relevance to the present disclosure is patent [U.S. Pat. No. 8,096,787] by Green, R. which discloses an efficient engine for converting steam to motive power to turn a common electrical generator thus generating electrical power. By using the word generator, we include also an equivalent alternator. An efficient engine of this type will help to minimize the size of heat generating device needed to power it. Another example of such a device is disclosed by Pritchard, E. in [US20060174613]. These engines are potential candidates for use in converting heat to electricity, but are much more complex than commercially available turbines which should have substantially longer lifetimes with less ongoing maintenance. A disadvantage of all prior art regarding the conversion of heat to electrical power is that no prior art exists wherein the heat from a low-power plasma source generating an ion beam is converted to electrical power using a vapor turbine or engine driving a generator or alternator.

Commonly experiments in cold fusion involve the use of a target to trap hydrogen or deuterium nuclei within a metal lattice. There is experimental evidence that alteration of the lattice structure, for example by including ZrO₂ nanoparticles in its formation, significantly increases the chances of reproducing the cold fusion reaction, as in patent application [US2016.0329118A1]. Recently the capability to fabricate metal parts using 3D printing has become more common, as in [US20150283751A1]. Our research indicates that 3D printing can alter the lattice structure of a printed component. Use of 3D printing to fabricate a target for cold fusion and thereby improve the ability of a metal lattice to accept the heat from an ion beam whilst resisting ablation or to hold Hydrogen or Deuterium nuclei more firmly for cold fusion has not previously been proposed.

### SUMMARY OF THE INVENTION

The present disclosure is for a device and a method for creating heat energy optionally utilizing cold fusion which contains numerous improvements over previous attempts. Cold fusion in this context means nuclear fusion reactions altering the nuclei of the reacting atoms producing heat well in excess of both input power and known chemical reactions of the components, consuming a smaller quantity of fuel to create said heat than any known chemical reaction of the components, occurring at a relatively low temperature (below the melting point of the target material), producing no greenhouse gas emissions, and no significant quantities of radiation or radioactive byproducts.

In common with most of its predecessors, an embodiment of this invention generates heat and optionally a cold fusion reaction to supplement that heat in a target in a reaction chamber under supervision of a controller and transmits the heat from the reaction to a set of devices which can use it directly for heating for a variety of applications such as heating water or space heating, as well as to generate electricity through means well-known to those skilled in the art. In common with the approach of Yuki, et.al. [cited above], an embodiment of this invention retains the reaction chamber in a partial vacuum and provides in common with the approach of Neri, et. al. [cited above], an attached plasma chamber also retained in a partial vacuum. In this context the term partial vacuum refers to a vacuum sufficient not to interfere significantly with the ion beam, in practice pressures of 6×10⁻⁵ mbar or less.

Embodiments of the invention disclosed herein are an improvement on the approach of Yuki et.al. [cited above] because they extract much stronger beam of ions from a low-power, low-temperature plasma. In using the term low-power, if the power cost to create and accelerate the beam is low compared to the heat and/or power the beam can generate, the source can properly be described as a low-power source. A fuel container is the source of the atoms used to form the plasma and is attached to the plasma chamber. A beam of ions extracted from the plasma chamber using the potential electrical energy of charged electrodes will be accelerated by those electrodes, converting the potential energy of the electrodes into kinetic energy of the ions, which will then impact a target in a reaction chamber to generate heat upon impact due to the kinetic energy of the ions. Heat generated by kinetic energy of the ions striking the target does not require a cold fusion reaction. Therefore, an important feature of this disclosure is the ability to generate heat by kinetic energy, which may be sufficient to reduce or eliminate the heat generated by cold fusion. Embodiments of this invention can include a method whereby the controller repeatedly alternates between optionally enriching the target with cold fusion ions and/or optionally depositing additional target material which may have been ablated by the beam and, once sufficient enrichment and/or repair have been achieved and there is a demand for power, uses the ion beam to impact the optionally enriched target and initiate heat and optionally sustain cold fusion. Since not all the fuel coming into the plasma chamber is captured into the plasma, and since some of the ions impacting the target will not create a nuclear reaction but will instead recombine back into fuel gas with the electrons from a slight negative charge that is being applied to the target, a further improvement is—as a byproduct of maintaining the vacuum level in the chambers—to capture the excess fuel gas from both chambers and recycle it to the fuel tank and/or the plasma chamber to be used again as fuel for the plasma.

### BRIEF DESCRIPTION OF THE DRAWINGS

An exemplary embodiment of the present invention is illustrated by way of example in the accompanying drawings in which like reference numbers indicate the same or similar elements and in which:

FIG. 1 is a diagrammatic representation of an exemplary device within which an embodiment of the present invention may be deployed;

FIG. 2 is a diagrammatic representation of an exemplary device capable of presenting alternative sides of the target for enrichment, replenishment and generating heat optionally supplemented by cold fusion;

FIG. 3 is a diagrammatic representation of a exemplary device which can separate active from passive fuel components and recycle excess fuel components for reuse;

FIG. 4 is a diagrammatic representation of an exemplary embodiment of a state-transition diagram of a method for controlling the modes of optionally enrichment, generation of heat and optionally cold fusion; and

FIG. 5 is a diagrammatic representation of an exemplary embodiment of a state-transition diagram of a method for controlling the modes of heat and or power generation when the required heat is fully supplied by the kinetic energy of the ion beam impacting the target.

### DETAILED DESCRIPTION OF THE INVENTION

In this section we will provide a detailed description of the preferred embodiment of the invention, mentioning in a few cases alternatives that might be useful in some applications.

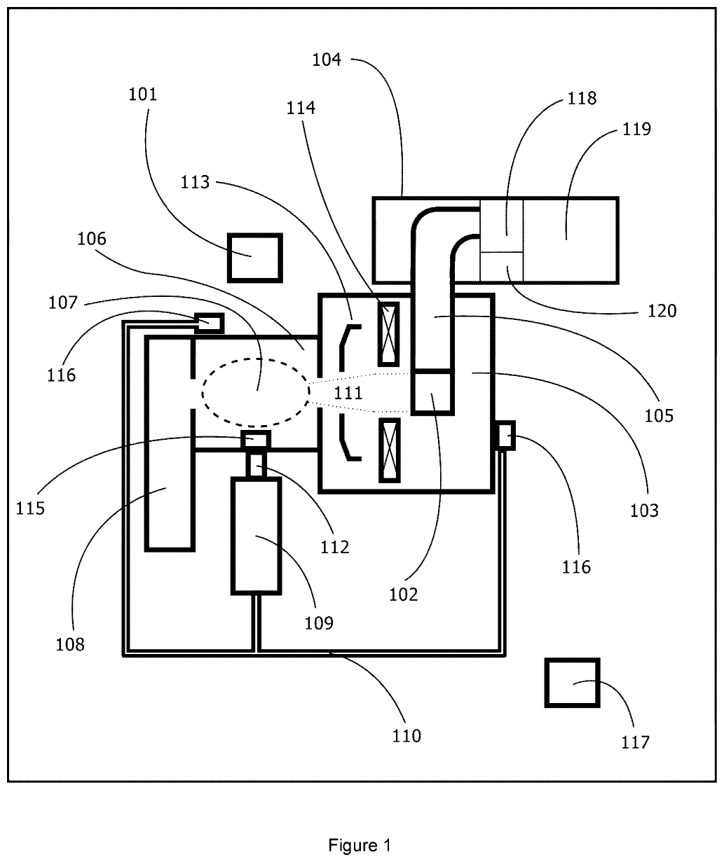

The preferred embodiment can be deployed in a diagrammatic representation such as FIG. 1. It is an important attribute of the invention that embodiments of the invention can be scaled up or down to fit the application, so there is no scale referenced in FIGS. 1-3.

Referring to FIG. 1 the preferred embodiment of the current invention incorporates a controller (101) for managing heat generation optionally utilizing cold fusion. The controller receives input from a variety of sensors positioned throughout the device and controls the startup, shutdown, vacuum concentration, fuel flow, plasma generation, ion beam extraction, ion beam speed and density and focus, target enrichment and cold fusion within the target, as well as recovery of unused fuel components for recycling to be used again as fuel, heating applications, and electricity generation among other parameters well-known to those skilled in the art. To reduce complexity in the presentation only a few of the sensors and none of the connections (which may use electrical wires, optical connections or wireless connections) between the controller and the device are shown in the Figures; these are easily provided by those skilled in the art. A deep cycle battery (117) is optionally included in the preferred embodiment for initiating operation of the device from a cold start, after which the controller maintains the charge in the battery in a manner to best extend its life and to provide restart capability in the manner known to those skilled in the art. Since the engine will run continuously for long periods of time without requiring shutdown or restarting, it will be possible to supply the startup energy from a portable battery brought to the engine for the purpose of infrequent startup, removing the need to include optional deep cycle battery (117).

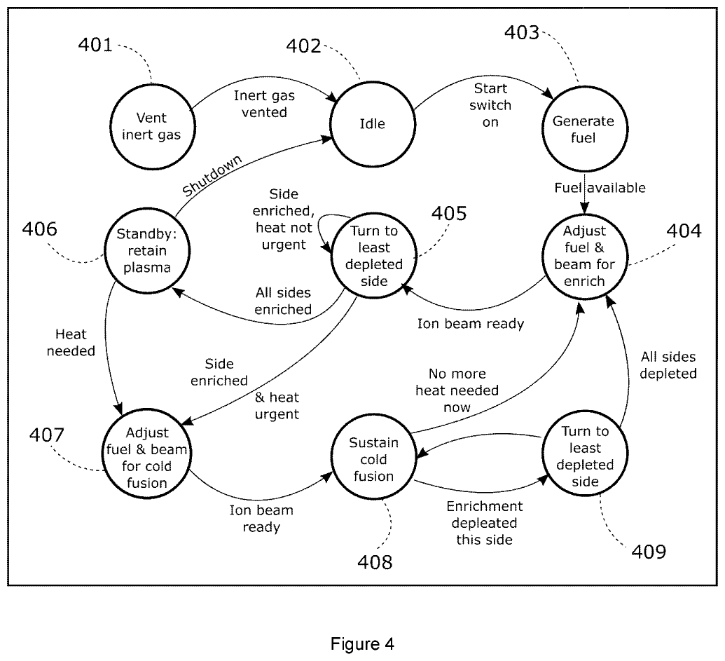

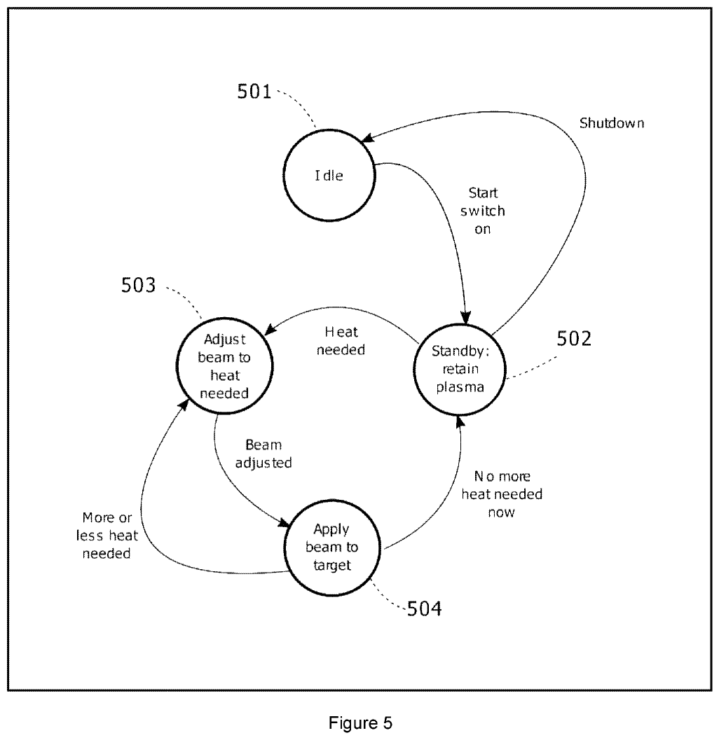

The preferred embodiment incorporates a reaction chamber (103) which holds the target (102). For brevity of explanation in the remainder of this section, by “target” we mean a target which generates heat when struck by the ion beam and which optionally generates additional heat using cold fusion. The target is maintained at a negative potential to provide electrons to combine with ion beam nuclei which are not consumed by cold fusion or some other reaction with the target. In the preferred embodiment when cold fusion is required the target is a metal or metal alloy selected from a group usually consisting of the Group 10 elements of the Periodic Table in combination with inert molecules such as ZrO₂, but as mentioned in the Background section other target materials can be used. If cold fusion is not required, the selection of potential target materials is broadened, permitting choice of a material or alloy which is particularly impervious to ablation by the ion beam and possible deterioration by hydrogen embrittlement if hydrogen ions are used. In the preferred embodiment the ion beam does not attain sufficient energy to cause ablation of the target, but there may be applications where such ablation would be encountered. The determination of whether and how much cold fusion is required in a particular embodiment is made by realizing that increasing the kinetic energy of the ion beam collision with the target to generate more heat increases the dimensions and weight of the device, the length of which must increase to include additional low-power electrodes as additional kinetic energy is imparted to the ion beam [Cockcroft & Walton], and the height, width and weight of which must increase to accommodate additional insulation from ground since more acceleration will involve operating the device at higher voltages. Additional heat, which we call ancillary heat, generated by operating parts of the device such as but not limited to the plasma chamber (106), the pumps (115, 116), the turbine (118), and the generator or alternator (119) can be routed to the heat exchanger (105) to further reduce the need for cold fusion heat (routing not illustrated), with an additional increase in weight. Therefore, the more heat that can be provided by cold fusion, the smaller and lighter can be the device. Other considerations may influence whether to incorporate cold fusion as a primary or supplemental source of heat, such as the longevity of target material sustaining cold fusion, the complexity of the control regime (see discussions of FIGS. 4 and 5, below), and even regulatory issues in a particular jurisdiction which might limit the use of cold fusion. We assume that in the preferred embodiment a cold fusion reaction will be required, because this will enable a smaller, lighter device to generate a given amount of heat and power. In the preferred embodiment the target of a cold fusion reaction is constructed to hold the enrichment fuel nucleons firmly within the lattice interstices in preparation for cold fusion, for example by fabricating the target using 3D printing and/or by forming the target from an alloy including lattice distorting molecules like ZrO₂. The reaction chamber is partially evacuated prior to and continuously during operation to permit the efficient enrichment of the target and subsequent cold fusion reaction by the beam of ions (111). Evacuation is accomplished by potentially multiple pumps (116) which are capable of venting as well as recycling unused fuel via component (110). Only the recycling path back to the fuel container is shown in FIG. 1. For simplicity the venting path and an optional path for recycling unused fuel directly back to the plasma chamber (106) are not shown, however, these can easily be provided by those skilled in the art.

Assuming cold fusion is desired in addition to heat from the ion beam colliding with the target, the preferred embodiment retains fuel for enrichment of a cold fusion target and for initiating and sustaining cold fusion in a container (109). In a more complex implementation, an additional source of target ions could be supplied for replenishing the target should it become ablated by the collisions with the ions in the ion beam. This additional input to the plasma chamber is not shown but could easily be devised in a fashion similar to the fuel chamber (109) and switched into operation when required. In the preferred embodiment, the fuel provides D₂ gas to the plasma chamber, but as noted in the Background section alternative fuels are possible. The preference for D₂ derives from the fact that D⁺ from the ion beam (111) impinging on D⁺ enriched in the target (102) resulting in a cold fusion reaction yields only ⁴He helium, an inert gas with no negative environmental impact. Alternatively, any fuel which will form a plasma under the influence of a low-power input source may result in a suitable embodiment. In particular if the ion beam collision supplies sufficient heat that cold fusion is not required then the choice of fuels is broadened to include for example the inert gases such as ⁴He helium among others; in this case then ⁴He is not a product of a cold fusion reaction but instead a source of ions for generation of heat by collision with the target. If cold fusion is not required, then in the preferred embodiment we would use pure copper for the target material, since it absorbs incoming ions with reversible distortion as the ions boil back out into the reaction chamber. The advantage of the inert gases like ⁴He in such an embodiment is their ability to be fully recovered post collision for reuse as fuel. The fuel container is attached to the plasma chamber (106) with a vacuum-sustaining coupler (112) common to the art of gas delivery systems. The coupler permits the fuel container to be removed for refueling or exchanged with another full or partially full fuel container. In an implementation where cold fusion is not required and for example an inert gas such as ⁴He is used as the fuel then nearly all of the inert gas will be recovered and the need to exchange the fuel container to replenish the fuel is removed (a small amount of inert gas may remain within the copper lattice.) In this case the coupler (112) can be of a simpler, more permanent form. The pump (115) transfers the fuel to the plasma chamber (106) under the dictates of the controller (101) controlling the fuel flow rate.

A low-power, low-temperature plasma (107) is maintained by the controller when needed in the plasma chamber and in the preferred embodiment is created by a low-power microwave generator (108) connected to the plasma chamber as described in the literature for proton sources for linear accelerators cited in the Background section [Neri, et. al.]. In this context the term low-power means low relative to the power the device can generate.

At least one but usually a multiple of electrical components (electrodes) with disc-shaped fronts facing the plasma with holes in the center for passing the ion beam (113) and zero or more disc-shaped low-power and/or permanent focusing magnetic (114) components with holes in the centers for passage of the ion beam are activated by the controller (101) to extract the ion beam from the plasma when required for target enrichment, target replenishment, or heat and optionally cold fusion. For diagrammatic simplicity only one of each component (113, 114) is shown in FIG. 1, but in the preferred embodiment there are a plurality of each to closely control the speed and focus of the ion beam as discussed in the article cited in the Background [Neri, et. al.] and known to those skilled in the art. In the preferred embodiment, a plurality of low-power electrodes and permanent magnets are interspersed with each other to obtain an optimal beam shape and speed to impact the desired fraction of the target surface. The number and strength of these depend on the energy requirement for the ion beam. In the preferred embodiment, in addition to the routine extraction of the ion beam, additional electrodes and magnets are installed to further accelerate and focus the ion beam in order to attain the speed and focus necessary to enrich the target lattice efficiently during enrichment mode, to replenish the target after ablation (if any), to generate heat by collision with the target, and—during an optional cold fusion mode—to assist in overcoming the Coulomb barrier between the enriched D⁺ ions in the lattice and the incoming D⁺ ions in the beam. In the preferred embodiment the focusing magnets are permanent ring magnets comprised for example of SmCo or NeFeB alloy in order to provide a focusing capability without drawing power. SmCo permanent magnets can withstand higher temperatures than NeFeB magnets. But even in this case it may be important that the magnets be temperature insulated from the rest of the apparatus to retain low enough temperatures to avoid deterioration (insulation not drawn).

In the preferred embodiment the heat from the ion beam collision with the target and the optional cold fusion reaction is transferred via a heat exchanger (105) to a set of components (104) that either utilize the heat directly, to heat water and/or space heaters for example, and/or to transform the heat into electricity. In the preferred embodiment the heat exchanger (105) is a flash point boiler because our disclosure has a focused point of heat, which is quite different from a traditional power generation boiler utilizing heat from burning fossil fuels in a large fire chamber, or from a geothermal heat source. In the preferred embodiment the set of components (104) is a closed system comprised of the heat exchanger (105) containing a liquid such as water but preferably a hydrocarbon such as pentane, which by heat is converted into a vapor. For clarity we should state that in using the word “vapor” we refer to the gaseous state of the material in the heat exchanger (105), such as steam if the material in the heat exchanger is water, or pentane gas if the material is pentane. In the preferred embodiment pentane is used because it boils at a lower temperature and does not form droplets, thus prolonging the longevity of the turbine or steam engine. The vapor drives a vapor-driven engine or turbine (118). In the preferred embodiment we would use a vapor-driven turbine due to the simplicity of its construction and consequent longevity, but any suitable vapor-driven engine would suffice. The vapor-driven turbine (118) drives a generator or alternator (119) producing electrical power, spent vapor then being condensed back to liquid form in a condenser (120).

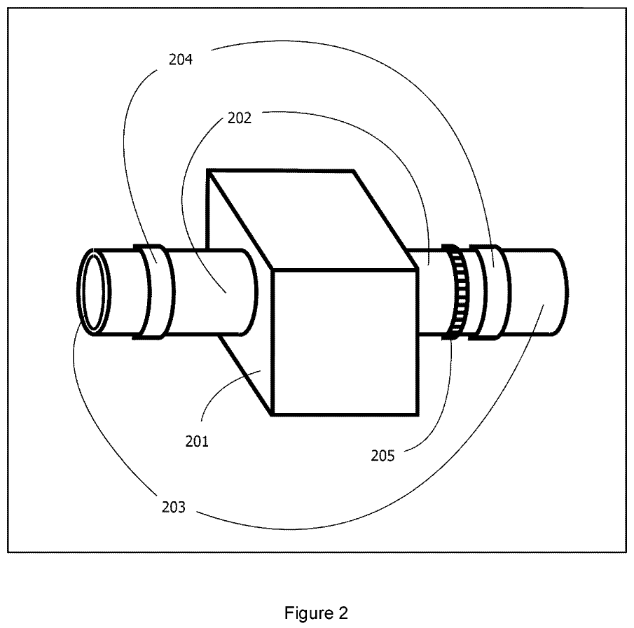

In the preferred embodiment the target (102) and the heat exchanger (105) are constructed so that portions of the target can be awaiting enrichment or replenishment whilst other portions can be used for cold-fusion, and vice-versa. In the preferred embodiment the combination of (102) is a so-called “field replaceable unit” so that the target can be periodically inspected and/or replaced with minimal effort. In the preferred embodiment a sensor—for example a measurement of resistance of a target side in an embodiment where it is insulated from the other sides—can be used to determine the degree to which a side of the target has been enriched, as known to those skilled in the art [Bok]. An alternative embodiment is for the controller to simply keep track of the time spent enriching and the time spent ablating and/or depleting the target side and use the previously measured properties of the target to determine when a side is in need of replenishment or is fully or partially enriched. FIG. 2 is a diagrammatic representation of an exemplary device capable of presenting alternative sides of the target for enrichment, ablation replacement and cold fusion and/or kinetic heat generation. The preferred embodiment is comprised of a hollow shaft (202) fixed to the target (201) shown here as a cubic object, but many geometric shapes with multiple sides are possible depending on the application. The portion of the shaft passing through the target is comprised of a material closely matched to the target in thermal expansion. For example, if the target were palladium, thermal expansion is 11.8 μm/(m·K) (at 25° C.), it is matched well by Copper-Base Alloy—C46400 also known as Naval brass. The remainder of the shaft (203) external to the target is preferably constructed of heat insulating materials.

The ends of the shaft fixed to the target are attached to high-temperature resistant swivels (204) which permit the target to rotate to face the ion beam as dictated by the controller. The other sides of the swivel are attached to fixed hollow shafts (203) which lead to the heat exchanger (105). A gear (205) is attached to the portion of the shaft fixed to the target to permit precision rotation of the shaft by a worm gear (not shown) driven by a stepper motor or similar component well known to those skilled in the art. An alternative to or in combination with the device of FIG. 2 is the ability (not drawn) to move the target vertically and/or horizontally to present different portions of the target for optionally enrichment, optionally replenishment, heat by collision and optionally by cold fusion. The target need only be shifted the diameter of the beam plus a small margin to present a fresh surface for any mode.

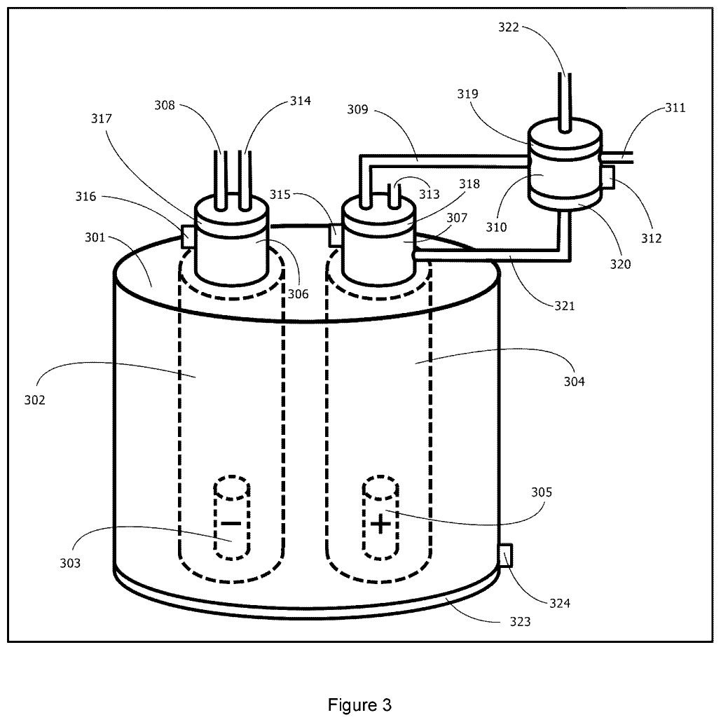

FIG. 3 is a diagrammatic representation of an exemplary device capable of retaining a liquid fuel comprised of passive and active components that can be separated into active fuel and passive by-product on demand. In the preferred embodiment wherein cold fusion is desired the fuel container (301) contains initially primarily fuel in the form of D₂O commonly known as Heavy Water, with the active fuel component being D₂ and the passive fuel component being O₂. In alternative implementations any fuel which can yield ions in the plasma which can be used to effect heat and optionally cold fusion in the target could be employed. The component (323) is a heater, under dictates of the controller (powered when the system is not in operation by the battery (117), and when the system is in operation by heat from the target), which assures the contents of the container are kept in a liquid form in low temperature environments. In an alternative embodiment the fuel container holds D₂ gas compressed possibly even to liquid form, or similarly H₂ gas or even where cold fusion not required some other element(s) such as ⁴He. Such a container is simpler than that shown in FIG. 3. Nonetheless, in the case where cold fusion is required to attain operating temperatures, this is not preferred because hydrogen gas is combustible with oxygen in the air in a strongly exothermic chemical reaction, which might present a hazard were an accident to occur during shipping or operation. Heavy Water is not combustible nor very toxic and with an inert gas filling the gas chamber portions of the container (306, 307) during shipping and storage or extended quiescence, the container remains completely safe.

In the preferred embodiment, the container (301) includes chambers (302, 304) for isolating the active component from the passive component. Using simple electrolysis, cathode (303) produces D₂ gas, and anode (305) produces O₂. D₂ gas is collected in the active chamber (306), and O₂ gas is collected in the passive chamber (307). As the liquid is consumed, the controller uses sensor (324) to read and report the fuel level to the operator. During startup, first sensors (315, 316) are read to determine that there is no appreciable liquid in the gas chambers. In the preferred embodiment, the device will not start with appreciable liquid in either chamber indicating the device is not horizontal enough to sustain gas in the chamber(s). In a possible embodiment, the entire fuel container (301) can be mounted on swivels to accommodate operation when the device is not substantially vertical. Additionally, the fuel container (301) can be mounted on a centrifugal device for operation outside any appreciable gravitational field. Pumps (317, 318) exhaust any inert gas that may have been added for shipping from the chambers to the atmosphere or to collection through vents (313, 314), then the active and passive fuel components are generated. Once sufficient quantities of components are reached, the active fuel component D₂ is delivered under the dictates of the controller (101) by pump (317) to the plasma chamber through a conduit (308).

During operation the passive fuel component O₂ is transferred by pump (318) through conduit (309) to recombination chamber (310). Here, pressure and other parameters are monitored by sensor (312). Excess fuel D₂ unused in the plasma or the cold fusion reaction enters through conduit (311, 110) to be combined with the O₂ back into D₂O by means well known to those skilled in the art. Transferring excess fuel D₂ or ⁴He unused in the plasma or the heat and optionally also cold fusion reaction directly to the plasma chamber is an alternative embodiment not illustrated. When according to sensor (312) there is enough Heavy Water accumulated, pump (320) transfers it back to the fuel container (301) through conduit (321). Helium gas remaining after the recombination reaction, along with excess O₂, is vented to the atmosphere or to collection for recycling by pump (319) through conduit (322).

The recycling of unused fuel is discussed above in paragraphs [0014], [0024], [0025] and [0033] and is supported in the case where cold fusion is desired by FIG. 3. In those embodiments where cold fusion is desired, in the preferred embodiment the fuel is D⁺ ions as discussed in paragraph [0025]. As noted in paragraph [0033], excess D₂ molecules which form in the reaction chamber from D⁺ ions which did not combine into ⁴He in a cold fusion reaction will be removed from the reaction chamber (along with any ⁴He which did form from cold fusion) by the vacuum pump (116) and returned to the recombination chamber (310). When the pressure in this chamber as monitored by sensor (312) is high enough, the passive fuel component O₂ from the earlier electrolysis and D₂ from the reaction chamber are recombined into Heavy Water which is fed back to the fuel container (301). Any ⁴He resulting from the cold fusion reaction which has been pumped into (310) will not combine into Heavy Water but instead will remain a gas, and can therefore be vented to the atmosphere or retained for recycling using pump (319) and conduit (322). In the case where cold fusion is desired, this is an embodiment of a method for recycling the unused fuel D₂. As mentioned in paragraph [0025], in those cases where cold fusion is not desired the fuel can be ⁴He ions. As noted briefly in paragraph [0033], in those cases where cold fusion is not desired and ⁴He is the fuel, the recycling path is much simpler. The high-speed He ions impact the target, where they pick up electrons and return to ⁴He atoms to be removed from the reaction chamber (103) by the vacuum pump (116) and can be returned directly to the plasma chamber in an alternative embodiment not illustrated, as mentioned in paragraph [0033] and easily accomplished by those skilled in the art.

The preferred embodiment includes a method for guiding the activity of the controller (101) for starting, enriching the target with fuel ions, initiating and sustaining cold fusion, reverting to target enrichment when not needing heat from cold fusion, and reverting to cold fusion when heat is needed, entering in to a standby state, and shutting down. FIG. 4 is a diagrammatic representation of an exemplary embodiment of a state-transition diagram of a method for controlling these states, assuming cold fusion is utilized. Controller (101) has additional functions of monitoring and control not shown in FIG. 4, which can easily be provided by those skilled in the art. Also, if cold fusion is not needed and heat is only provided by the collision of the ion beam with the target and or ancillary heat from operating parts, FIG. 4 can be modified by anyone skilled in the art, with FIG. 5 being an exemplary result. Similarly, if the target were to require replenishment with target atoms which have been lost to ablation by the ion beam, FIG. 4 can be modified to accommodate this case also by anyone skilled in the art. What follows now is a simplified embodiment, upon which many refinements can be introduced, which assumes the use of cold fusion to generate heat, and no appreciable ablation of the target in the process. Our objective here is to disclose an exemplary embodiment that will enable those skilled in the art to implement the invention with any modifications to suit their application easily adopted as required by those skilled in the art.

In the preferred embodiment the device controller (101) starts when installed in state (401) by venting the inert gas stored in the collection chambers (306, 307) for shipping. As the inert gas is vented, some initial electrolysis fills chambers (306) and (307) with active and passive fuel components respectively, and once the chambers are full to starting pressure the controller enters the idle state (402). All functions are shut down in this state, except the optional battery (117) can if present power the controller, the heater (323) and any other critical components not detailed herein. When a start switch common to the art is turned on, the device enters the state (403) wherein the electrolysis restarts and the active fuel component is again generated. Once fuel is continuously available a state (404) is entered wherein the fuel flow and ion beam are set to enrichment of the target with ions. As long as fuel is flowing, chambers are actively maintained in partial vacuum and any unused fuel is recycled to be reused. When the ion beam is ready, a state is entered where the least depleted, un-fully-enriched side is presented to face the ion beam (405). If target sides are tied for depletion, a tie-breaker is implemented, such as the closest side to the ion beam is selected. When the side is enriched, which can be determined either by time or by sensor, if heat is not required the state (405) is re-entered to present the next least depleted, un-fully-enriched side to the ion beam.

When all sides are fully enriched and heat is not immediately required, a stand-by state (406) is entered. Plasma is retained active, but fuel only needs to trickle to replace any plasma lost to the plasma chamber. The recycling of fuel is maintained as required to retain the partial vacuum in both chambers. To conserve battery over extended periods, the controller can be configured to enter the idle state (402) upon operator command or automatically after a certain time has elapsed in stand-by state. Once heat is needed, state (407) is entered from stand-by state (406).

Returning again to state (405), if a side is enriched and heat is required urgently, then further enrichment is deferred and the method enters state (407) wherein the fuel flow and the ion beam are adjusted for cold fusion. Once the ion beam is ready, cold fusion is sustained in state (408). If during cold fusion the controller detects that enough heat has been generated for the time being, state (404) is re-entered. On the other hand, if state (408) persists until enrichment is depleted on the current side, determined either by sensor or by timing, state (409) is entered and the next least depleted side is presented to the ion beam and state (408) is re-entered, assuming at least one side retains some enrichment. If all sides are depleted, state (409) is left by a re-entry to state (404).

The controller is capable of a wide variety of refinements on this method, which might be useful in particular applications. To give one example, whilst in state (405) it might be desirable to transition to state (407) before any side is fully enriched. This would depend on the urgency of the requirement to begin generating heat, and the length of time for which heat will be required before further enrichment would be necessary. A large number of such details are best left to a particular application, and easily implemented by those skilled in the art.

FIG. 5 is a diagrammatic representation of an exemplary embodiment of a state-transition diagram of a method for controlling (101) the device when cold fusion is not required because all of the heat needed for heat and power generation is supplied by the optionally accelerated ion beam impacting the target. This is obviously a much simpler control regime than FIG. 4, since it does not require many of the features which may be required to sustain cold fusion reactions. In the preferred embodiment where all of the heat is generated by the kinetic energy of the ions impacting the target, the fuel would be ⁴He helium and the target could be composed of pure copper. Helium is chosen because it can be ionized by the previously discussed low-power microwave device so that required input power can be retained well below the output power generated. Furthermore, helium is unlikely to combine chemically with the target or the interior walls of the plasma or reaction chambers, enhancing longevity of the device. However, any other ion could be used. Similarly, pure copper is chosen as the target because of its excellent heat-transfer properties, high melting point, ability to reverse any distortions imparted by the collisions and disinclination to combine with incoming ions. However, any other target material with similar characteristics could be used.

In the case where heat is provided by kinetic energy of the incoming ions colliding with the target and optionally by ancillary heat from operating component(s), so that no cold fusion is required, the controller (101) begins in the idle state (501). Controller (101) has additional functions of monitoring and control not shown in FIG. 5, which can easily be provided by those skilled in the art. When the start switch is turned on, the controller enters the standby state (502) in which the plasma is being generated. When heat is needed, state (503) is entered and the beam is adjusted to the amount of heat needed by activating the required number of electrodes. Once the beam has been adjusted the controller enters the state (504) wherein the ion beam collides with the target, generating the required amount of heat. If the amount of heat needs adjustment, then state (503) is re-entered, and if no more heat is needed, then state (502) is re-entered. Upon shutdown, the controller returns to the idle state (501). There are a wide variety of possible refinements that can be added to FIG. 5, for example a state wherein the target is replenished with target ions if the target has experienced ablation due to the incoming ion beam, or incorporation of various elements of FIG. 4 to support cold fusion if that is needed in the application. We leave these refinements to be added as required for a particular application by those skilled in the art.

FIGS. 4 and 5 represent two extremes of control regimes which could be implemented in a given application. As noted above, the amount of heat supplied by kinetic energy, ancillary components and cold fusion is a design decision in a given implementation and in fact may vary during application as required. If a blend of kinetic, ancillary and cold fusion heat is desired in a given application, then the fuel in the preferred embodiment would be D₂. This avoids the complexity of switching between D₂ and ⁴He during operation. However, an implementation which switches and even which combines these fuels is possible, and can be chosen if appropriate to the particular application. Similarly, when cold fusion heat is being generated along with kinetic and possibly ancillary heat, then the preferred embodiment would use a Group 10 alloy for the target, which as noted above assists in the promotion of cold fusion. However, a blend of target could be used and materials could also be alternated during operation as required, using a mechanism similar to that exemplified by FIG. 2. Finally, although the speed of the ions can be controlled by increasing or decreasing the voltage in the CW accelerator electrodes [Cockcroft & Walton], in the preferred embodiment as in historical linear accelerators this is unlikely to be required very often since the ion beam can operate at a steady state (504) in the case where cold fusion is not required, or in one of at most a couple of steady states (405, 408) in the case where cold fusion is required. With the constant supply of fuel to the plasma chamber through pump (115) and the constant application of extraction and acceleration voltage, the ion beam will be continuous in its impact on the target and the consequent generation of heat. As noted in paragraph [0027], the use of permanent magnets along the ion beam to keep it focused so that the beam does not strike the electrodes used for extraction or acceleration means that beam shape can be maintained to impact the target as desired with no power cost.

As indicated above [0024], the more energy that can be generated by cold fusion, the smaller and lighter the embodiment will be. By varying a 1 mA beam from 2.5 to 6.5 keV in small increments, the work of [Yuki, et. al.] demonstrated the amount of cold fusion produced was exponentially proportional to the energy of the ion beam. In the years since those experiments, ion sources have been developed with an order of magnitude more energy in the ion beam (75 keV) and with a much lower power requirement [Neri, et. al.]. In addition to this much higher energy, the new ion sources produce beams with 75 times more ion current (75 mA). The device of [Neri] will thus produce 865 times more energy to the target than the device of [Yuki], with the amount of cold fusion exponentially larger (865=(75 keV/6.5 keV)*(75 mA/1 mA)). The precise amount of cold fusion that will be delivered by a particular embodiment of this disclosure will depend on many factors such as for example the alloy used in the target material. As mentioned frequently in this Description any shortfall in heat produced by cold fusion in a given embodiment for a particular industrial application can be compensated by imparting additional kinetic energy to the ion beam preferably by using a low-power accelerator such as a CW accelerator [Cockcroft and Walton].

Suppose for example a industrial application requires 25 kW continuous electrical power: more than enough power to fully supply an air-conditioned home in a tropical climate with a full complement of electrical appliances. A commercially available vapor-driven turbine and generator of this size requires 400 kg/hr of vapor, which is sufficient to generate the required power whilst overcoming any inherent mechanical inefficiencies. The preferred embodiment using a [Neri, et. al.] ion source generates an ion beam current of 75 mA, or 4.681×10¹⁷ ions/second. To demonstrate further the flexibility of this disclosure we will assume the use of benzene as an alternative hydrocarbon to pentane as discussed in [0028]. Heat of evaporation of benzene is 30.77 kJ/mol at 80.1° C. This is 393,911 J/kg which when multiplied by the required 400 kg/hr yields 43,768 J/s. Dividing this by 4.681×10¹⁷ ions/s gives an energy per ion of 9.352×10⁻¹⁴J/ion, or 583.6 keV/ion. Because the chambers are in vacuum of 10⁻⁵ mbar, all this energy goes into heat in the target when the ion collides with the target. This heat will be transferred directly to the benzene, producing the required 400 kg/hr of vapor. This beam energy is less than ⅕th the energy demonstrated by [Neri, et.al.] so is clearly achievable in the current art. The major input power requirements are the 1.5 kW required for the microwave [Neri, et.al.], and the hydrocarbon (in this case, benzene) pump which requires 0.75 kW. Additional components such as the vacuum pump and electronic controls require smaller amounts of power, the total being less than 3 kW, leaving 22 kW continuous power, still more than enough for the application. The present disclosure provides for important industrial application even if no cold fusion is provided in a chosen embodiment.

When some blend of kinetic ion beam collision heat, ancillary heat and cold fusion heat are employed in a particular application, then the actual control regime will be some combination of FIGS. 4 and 5, the fuels may be a blend or alteration of materials, and the target may be a blend or alteration of materials. Because of the large possible set of combinations of these components, it is not feasible to delineate all the possibilities individually. That there is a wide range of flexibility available will immediately be clear to any designer skilled in the art, who can then in the light of a particular application make the best choices of control regimes and materials. A clear benefit of this disclosure is that the wide range of design choices permits a device to be created that is tailored specifically to the application. Many of the most important attributes of this disclosure are beneficial to all the possible designs. For example, all of the implementations take part in the benefits of a simplified mechanical design with very few moving parts, most of which are bearings known to have a very long life.

1. A device comprising a controller for generating a cold fusion reaction in a target in a reaction chamber retained in partial vacuum being fed an ion beam from a plasma chamber to impinge upon the target generating cold fusion heat, wherein heat from the reaction is transmitted to a second set of devices by a heat exchange mechanism, wherein at least a first portion of the second set of devices configured to convert the heat into electricity and at least a second portion of the second set of devices are configured to use the heat directly, wherein a low-power microwave, creating and sustaining a plasma in the plasma chamber, is connected to the reaction chamber, a fuel container is connected to the plasma chamber for supplying fuel to the plasma chamber, wherein the controller repeatedly alternates between enriching the target for cold fusion and initiating and sustaining cold fusion and wherein a device for extracting unused fuel from both chambers to be recycled to be used again as fuel is supplied to the fuel container and/or to the plasma chamber.

2. A device comprising a controller for generating a cold fusion reaction in a target in a reaction chamber, wherein heat from the reaction is transmitted to a second set of devices by a heat exchange mechanism, wherein at least a first portion of the second set of devices is configured to convert the heat into electricity and at least a second portion of the second set of devices is configured to use the heat directly, wherein the reaction chamber extracts an ion beam which creates cold fusion in the target from a low-energy, low-temperature plasma created by a microwave device attached to a plasma chamber attached to the reaction chamber, wherein the plasma is fueled by a fuel container attached to the plasma chamber for supplying the ion beam to the reaction chamber, and wherein a device for extracting unused fuel from the reaction chamber and its attached plasma chamber recycles the unused fuel to either the fuel container or the plasma chamber to be used again as fuel.

3. A device comprising a controller for generating a plasma in a plasma chamber retained in partial vacuum from which a beam of ions is drawn to effect a cold fusion reaction in a target in a reaction chamber also retained in partial vacuum and attached to the plasma chamber, wherein heat from the reaction is transmitted to a second set of devices by a heat exchange mechanism, wherein at least a first portion of the second set of devices are configured to convert the heat into electricity and at least a second portion of the second set of devices is configured to use the heat directly, wherein a plasma chamber in which a low-energy, low-temperature plasma, created by a microwave device and fueled by a fuel container, supplies an ion beam to the attached reaction chamber to impact upon the target, and wherein a device for extracting unused fuel from the plasma chamber and its attached reaction chamber recycles the unused fuel to either the plasma chamber or the fuel container to be used again as fuel.

4. A method of initiating and sustaining a cold fusion reaction in a reaction chamber of the device of claim 1, the method comprising the steps of:
enriching a target to prepare it for cold fusion; and
initiating cold fusion whose heat can be used by the second set of devices, wherein the least a first portion of the second set of devices are configured to convert the heat into electricity and the at least a second portion of the second set of devices are configured to use the heat directly,
wherein the cold fusion reaction comprises: an idle state; a state for responding to a start command resulting in venting an inert gas used for safe shipping and storage; a state for starting generation of fuel; a state for adjusting fuel flow and an ion beam for enrichment; a state for turning an unenriched or partially enriched side of the target to the ion beam; a standby state wherein the plasma is retained but neither enrichment nor cold-fusion arc taking place; a state for adjusting the fuel flow and ion beam for cold fusion; a state where cold fusion is sustained to actively produce heat to be used possibly directly and possibly to generate electricity; and a state wherein the least depleted side of the target is turned to the ion beam to continue to provide heat from cold fusion.

5. The device of claim 1, further comprising: additional low-power electrodes and magnets to accelerate and focus the ion beam thus reducing or eliminating the requirement for a cold fusion.

6. The device of claim 2, further comprising: low-power electrodes configured to further accelerate the ion beam; and permanent magnets or low-power configured to focus the ion beam which creates heat from impact of the ion beam with the target in order to reduce or eliminate the requirement for the cold fusion reaction, wherein the ion beam is configured to optionally enrich the target.

7. The device of claim 3, further comprising: additional low-power electrodes, configured to accelerate and magnet, configured to focus, the ions to impact upon the target, thus generating heat from the impact and reducing or eliminating the requirement for cold fusion.

8. The method of claim 4, further comprising the step of: incorporating a simpler set of states, wherein cold fusion is reduced or not required.

9. A method of initiating and sustaining heat in a reaction chamber of the device of claim 5, the method comprising the stops of:
beginning in an idle state which is a state for responding to a start command;
retaining the plasma but not extracting a beam in a standby state;
adjusting the volume and speed of the ion beam using low power electrodes and adjusting the shape of the beam using low-power or permanent magnets; and
generating heat by impact of ions with a target configured to be used directly and configured to generate electricity;
wherein the method is readily modified to incorporate modes where cold fusion is required and also where the target needs to be replenished with atoms lost to ablation by the ion beam.

10. The device of claim 1, further comprising: a means for the controller to determine whether a portion of the target is enriched sufficiently to permit cold fusion to commence.

11. The device of claim 1, further comprising: a plurality of distinct optional modes controlled by the controller, including controlling the speed, shape, density and focus of an ion beam extracted from the plasma differently for each of the plurality of distinct optional modes, the plurality of distinct optional modes comprising:
a mode in which heat and optionally a cold fusion reaction is created by impinging ions into a side of the target thus generating heat;
a mode in which the target is enriched with impinging ions;
a mode in which the plasma is maintained intact but no ion beam extracted;
a mode in which the plasma is collapsed to fuel molecules and no ion beam can be extracted;
a mode for venting inert gas installed in the fuel container for shipping;
a mode for generating fuel for the device so that incoming fuel can be readily transformed into a low power, low-temperature plasma; and
a mode wherein the target can be replenished with atoms to replace any that have been lost due to ablation by the ion beam.

12. The device of claim 11, further comprising: a mode wherein a target with multiple sides can be rotated and each side successively enriched with ions absorbed into the target.

13. The device of claim 11, further comprising: a means to move the target and/or focus the ion beam so that the ion beam can focus on a portion of the target surface to enrich the target; and a means to move and/or focus the ion beam on a portion of the target to initiate and sustain the cold fusion reaction.

14. The device of claim 1, wherein the fuel container for creating the cold fusion reaction comprises a means whereby the fuel container can be attached and detached with a minimum loss of fuel.

15. The device of claim 1, wherein the fuel contained in the fuel container is in the form of a gas or a compressed gas, and wherein the gas is configured to be partially compressed to a liquid and/or to a solid form.

16. The device of claim 1, wherein the fuel container contains a liquid comprising of a set of active fuel components, a set of passive fuel components, and a set of devices for separating the set of active fuel components from the set of passive fuel components.

17. The device of claim 14, further comprising a means to heat the fuel container, wherein the means to heat the fuel container is configured so that the liquid does not freeze in low temperature environments.

18. The device of claim 16, wherein the set of devices are configured to be filled with inert gas for shipping.

19. The device of claim 16, wherein the set of devices are configured to be evacuated preparatory to a startup operation and filled with their respective operational components.

20. The device of claim 16, further comprising at least one monitor configured to detect that at least one gas extraction chamber is filled with liquid fuel due to disturbance during shipping or accident, wherein upon said detection the fuel is prevented from flowing and the entire reaction is placed into the shutdown mode

21. The device of claim 18, wherein operation is started only after the set of devices have been evacuated of inert gas and refilled with active and passive components, respectively.

22. The device of claim 16, wherein the controller is configured to vent the passive component to the atmosphere.

23. The device of claim 16, wherein the collected passive component can be recombined in a recombination chamber with the active component recovered front the chambers to resupply via a pump and a conduit.

24. The device of claim 12, wherein the device is switched to enrichment mode during periods when enrichment is required and heat is not required, and wherein the device is switched to heat and optional cold fusion mode when heat is required, and similarly for replenishment of the target surface following ablation by the ion beam.

25. The device of claim 24, wherein the target is rotated so the target side being presented for enrichment by the ion beam is not currently fully enriched, or the target side being presented for replenishment has been ablated.

26. The device of claim 12, wherein the target is attached to a shaft orthogonally to the ion beam and parallel to the axis of rotation, and wherein the shaft is fixed to the target and is connected in line to a fixed using a swivel so the shaft section attached to the target can be rotated using a gear to present the appropriate side of the target to the beam.

27. The device of claim 1, wherein shafts contact the target, and wherein the shafts are made of heat insulating material except where they contact the target.

28. The device of claim 27, further comprising a heat exchanger; a vapor-driven turbine or engine; a generator; and a condenser for producing electricity, wherein the vapor is pentane or another hydrocarbon compound or water.

29. The device of claim 1, wherein the target is formed 3D printing.

30. The device of claim 1, further comprising: a device for extending the heat exchanger to obtain ancillary heat from at least one component of the device, the at least one component comprising the plasma chamber, pumps, a vapor-driven turbine or engine and/or a generator reducing or even eliminating the requirement for heat from cold fusion and/or from kinetic energy of the ion beam.
